(19) United States
(12) Patent Application Publication
(10) Pub. No.: US 2007/0166004 A1
(43) Pub. Date: Jul. 19, 2007

(54) Robot system using menu selection card having printed menu codes and pictorial symbols

(75) Inventor: Kyoung Jin Kim, Seoul (KR)

Correspondence Address: BIRCH STEWART KOLASCH & BIRCH, PO BOX 747, FALLS CHURCH, VA, 22040-0747, US

(73) Assignee: iO.TEK Co., Ltd

(21) Appl. No.: 11/640,884

(22) Filed: Dec. 19, 2006

(30) Foreign Application Priority Data
Jul. 10, 2006 (KR) 10-2006-64195
Mar. 10, 2006 (KR) 10-2006-22819
Jan. 10, 2006 (KR) 10-2006-2553

(51) Int. Cl. H04N 5/91

(52) U.S. Cl. 386/83

(57) ABSTRACT

Disclosed herein is a robot system. The robot system includes a menu selection card, an optical reader, and a robot main body. Minute codes corresponding to respective menu options selectable in a robot system are printed on the menu selection card along with pictorial symbols corresponding to the respective menu options. The optical reader recognizes the minute codes corresponding to the respective pictorial symbols. The robot main body receives a minute code corresponding to a specific pictorial symbol, selected by the optical reader from the menu selection card, from the optical reader, and performs an operation corresponding to the received code.

### BACKGROUND OF THE INVENTION

1. Field of the Invention

The present invention relates generally to a robot system that uses a card on which minute codes readable by an optical reader are printed along with respective pictorial symbols.

2. Description of the Related Art

In the future, various types of home robots will be popularized at home, and various functions will be performed by such home robots. Representative fields of use of such home robots are the field of education by the playing of voice and video content (hereinafter referred to as “multimedia content”) such as English education or the telling of fairy tales, and the field of remote control of home robots that perform commands in order to control other devices using a home robot, etc.

Meanwhile, in a conventional home robot system, a user selects an action command or multimedia content to be played using a selection button on a home robot or a selection button on a remote control in a hierarchical manner. However, in such a selection button method, in the case where the number of action commands, the number of pieces of multimedia content or the number of other device control commands is low, selection using a selection button can be made in one step. In the case where the number thereof is low, it is possible to select one using a selection button in one step. In contrast, in the case where the number thereof is high, a desired action command, multimedia content or another device control command is selected by pressing several buttons in a hierarchical manner (a top-down fashion) because the number of selection buttons mounted on a home robot or remote control is limited, therefore it is difficult for a user to select a desired one thereof, and thus it is inconvenient to manipulate a robot.

Furthermore, for a selection button method, words or tiny pictorial symbols corresponding to respective descriptions of action commands, multimedia content or other device control commands are indicated near respective selection buttons of a remote control and or a home robot, therefore there are many cases where it is difficult for users, particularly infants or elementary school children, to identify which buttons correspond to which action commands, multimedia content or other device control commands by viewing the words or tiny pictorial symbols.

Considering that it is difficult to easily identify the functions of buttons using the hierarchical button manipulation method, there has been proposed a method in which a small-sized screen is provided to a remote control or a home robot, pictorial symbols corresponding to action commands or multimedia content are displayed on the small-sized screen, and thereby a user selects a desired action command or multimedia content by performing selection in a touch screen fashion. However, since, according to this method, a sufficient number of pictorial symbols cannot be displayed on the small-sized screen due to the size of the screen, there is a disadvantage in that the screen must be touched several times in a hierarchical manner in the case where the number of action commands or the number of pieces of multimedia content is high. Meanwhile, even if the size of the screen is increased, there is a limitation on the number of pictorial symbols that can be displayed on the screen.

In order to overcome the above problems, there has been proposed another prior art in which, when a user issues a command using a voice, a home robot or remote server recognizes the user's selection or command by recognizing the voice. However, this method is not desirable because there is inconvenience in that a user must know all voice commands, and the extent of recognition is low due to variation in pronunciation even if the user knows all voice commands.

### SUMMARY OF THE INVENTION

Accordingly, the present invention has been made keeping in mind the above problems occurring in the prior art, and an object of the present invention is to provide a scheme that, in a robot system, enables a user to easily select various menu options for action commands, multimedia content and other device remote control commands and to transmit them to a home robot or a remote server for a home robot.

In more detail, the present invention provides a scheme in which, when a user selects a specific pictorial symbol (corresponding to a specific action command or multimedia content) with an optical reader while viewing pictorial symbols using a card (hereinafter referred to as a “menu selection card”) on which minute codes readable by the optical reader are printed along with respective pictorial symbols corresponding to respective menu options, a minute code (hereinafter also referred to as “a menu code”), printed along with the selected pictorial symbol, is read by the optical reader and is then transmitted to a home robot or service server.

In order to accomplish the above object, the present invention provides a robot system, including a menu selection card on which minute codes corresponding to respective menu options selectable in a robot system are printed along with pictorial symbols corresponding to the respective menu options; an optical reader which recognizes the minute codes corresponding to the respective pictorial symbols; and a robot main body which receives a minute code corresponding to a specific pictorial symbol, selected by the optical reader from the menu selection card, from the optical reader, and performs an operation corresponding to the received code.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing minute codes printed on the menu selection card of the present invention;

FIG. 2 is a diagram showing a menu selection card on which pictorial symbols corresponding to menu options are printed along with minute codes;

FIG. 3 is a diagram illustrating a home robot system using the menu selection card of the present invention;

FIG. 4 is a flowchart illustrating a procedure of transmitting information about a menu option, selected by a user using the menu selection card of the present invention, to a home robot;

FIG. 5 is a diagram illustrating the menu selection card of the present invention, which is fabricated in the form of a menu book;

FIG. 6 is a diagram illustrating a specific song of the music menu book for Karaoke content of the present invention;

FIG. 7 is a diagram illustrating the menu selection card of the present invention that is applied to a multimedia publication;

FIG. 8 is a diagram illustrating the menu selection card of the present invention that is applied to interactive content;

FIG. 9 is a diagram illustrating a state in which a home robot, to the lower portion of which an optical reader is attached, is placed on the menu selection card of the present invention;

FIG. 10 is a diagram illustrating a code through which both a menu code and an absolute location code can be read;

FIG. 11 is a diagram illustrating the menu selection card of the present invention, which is a line tracing card; and

FIG. 12 is a diagram illustrating the menu selection card of the present invention, which is combined with a charging device.

### DESCRIPTION OF THE PREFERRED EMBODIMENTS

Reference now should be made to the drawings, in which the same reference numerals are used throughout the different drawings to designate the same or similar components.

First, a method of recognizing minute menu codes, printed on a menu selection card along with menu pictorial symbols, using an optical reader is described below.

In typical printing technology, a desired color is obtained by combining cyan (C) ink, magenta (M) ink, yellow (Y) ink and black (K) ink with each other, hue is obtained by adjusting the combination of C, M and Y, and brightness is obtained by adjusting K.

Meanwhile, an optical reader using infrared rays (for example, a 2D barcode reader or a Sonix Technology reader disclosed in U.S. Patent Application No. 2003/0133164A1) is used to recognize printed codes.

Here, since infrared rays exhibit high transmittance for C, M, and Y but absorb K, the infrared rays exhibit high brightness for C, M and Y but exhibits low brightness for K.

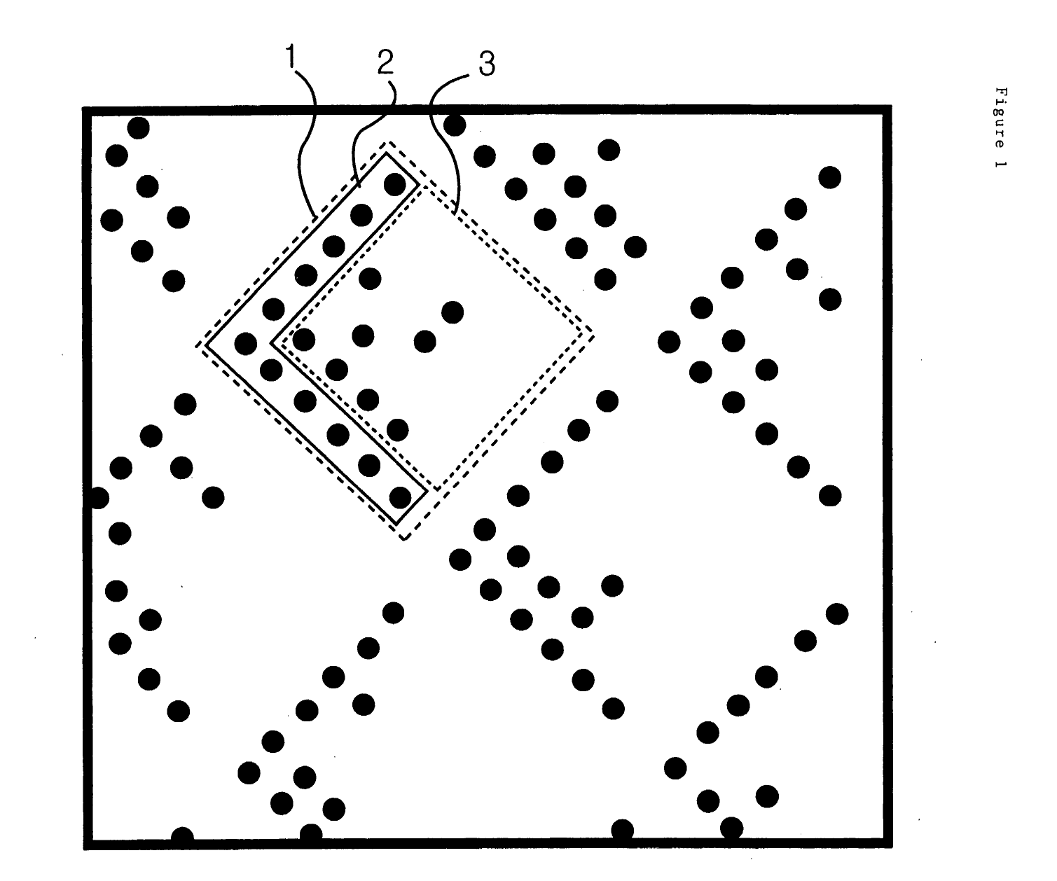

Accordingly, the pictorial symbols of the card are printed using combinations of C, M and Y. In particular, even if a black color for the pictorial symbols is printed using the combination of C, M, and Y, which nearly corresponds to K (dark indigo or dark black), humans visually recognize the combination as black. Meanwhile, pure black K is used to print the menu codes. By doing so, when an infrared ray is radiated onto the card on which the minute codes (printed in K) are printed along with the pictorial symbols (printed in combinations of C, M, and Y) using the optical reader, the pictorial symbols appear to be bright and the codes appear to be dark, therefore dark codes can be viewed, as illustrated in FIG. 1.

The codes may be constructed using various methods. For example, each code of FIG. 1 is composed of a code indicator 1. Each code indicator 1 includes a header part 2 that has an L shape, formed by six dots in a lateral direction and six dots in a vertical direction, and forms a reference for this code, and a code information part 3 that exists inside the header part 2 and indicates a code value.

The code information part 3 of FIG. 1 is formed in a 5×5 matrix, therefore a corresponding code value can be recognized via the dot pattern thereof.

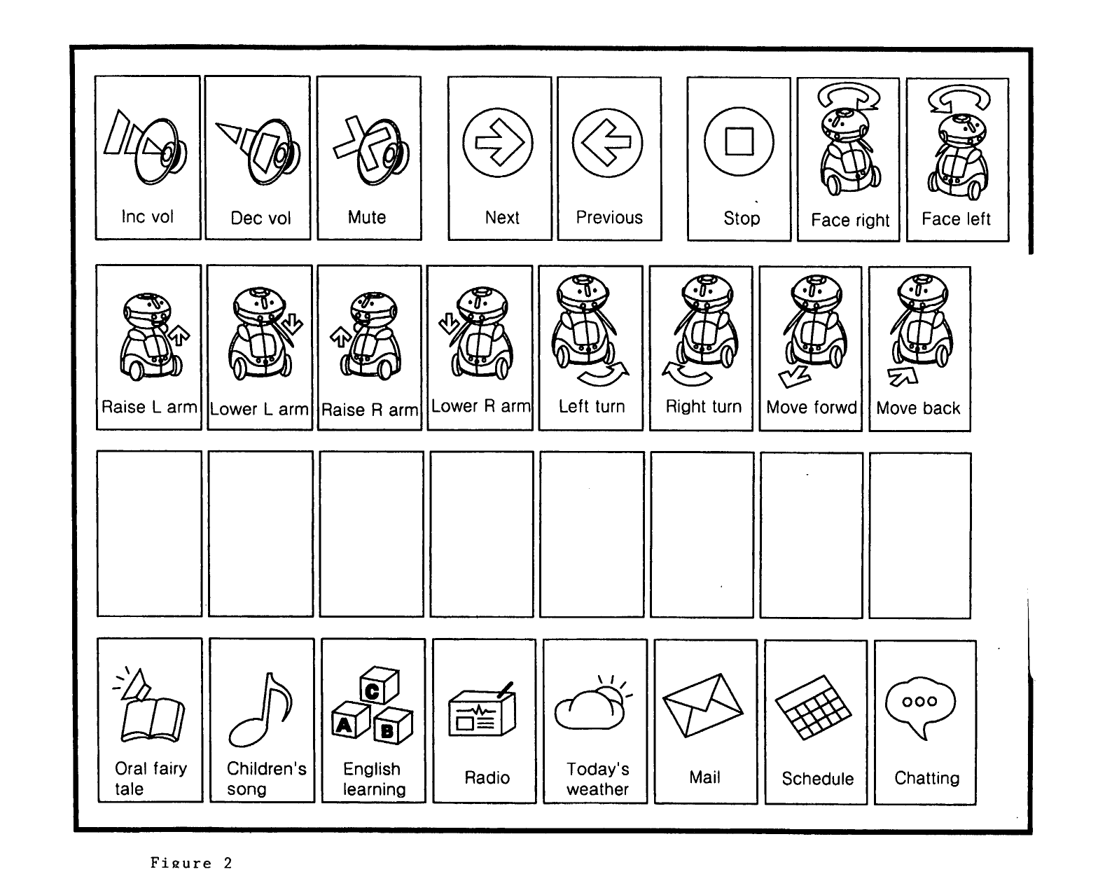

Next, in the menu selection card on which the pictorial symbols and minute menu codes corresponding to selectable menu options are printed, the pictorial symbols and descriptive text are described with reference to FIG. 2.

As illustrated in FIG. 2, pictorial symbols for facilitating the recognition of the meanings of various menu options are drawn on the menu selection card of the present invention.

For example, pictorial symbols for the selection of menu options corresponding to respective action commands for the home robot are drawn in rectangles in a range from the seventh rectangle of the first row of FIG. 2 to the last rectangle of the second row thereof, and pictorial symbols for the selection of various types of multimedia content are drawn on rectangles in the fourth row. A minute code corresponding to each pictorial symbol is not illustrated in FIG. 2, and is actually printed within the rectangular frame of the pictorial symbol using the above-described method. A user may directly draw desired pictorial symbols and write descriptive text in rectangles in the third row, which will be described in detail below.

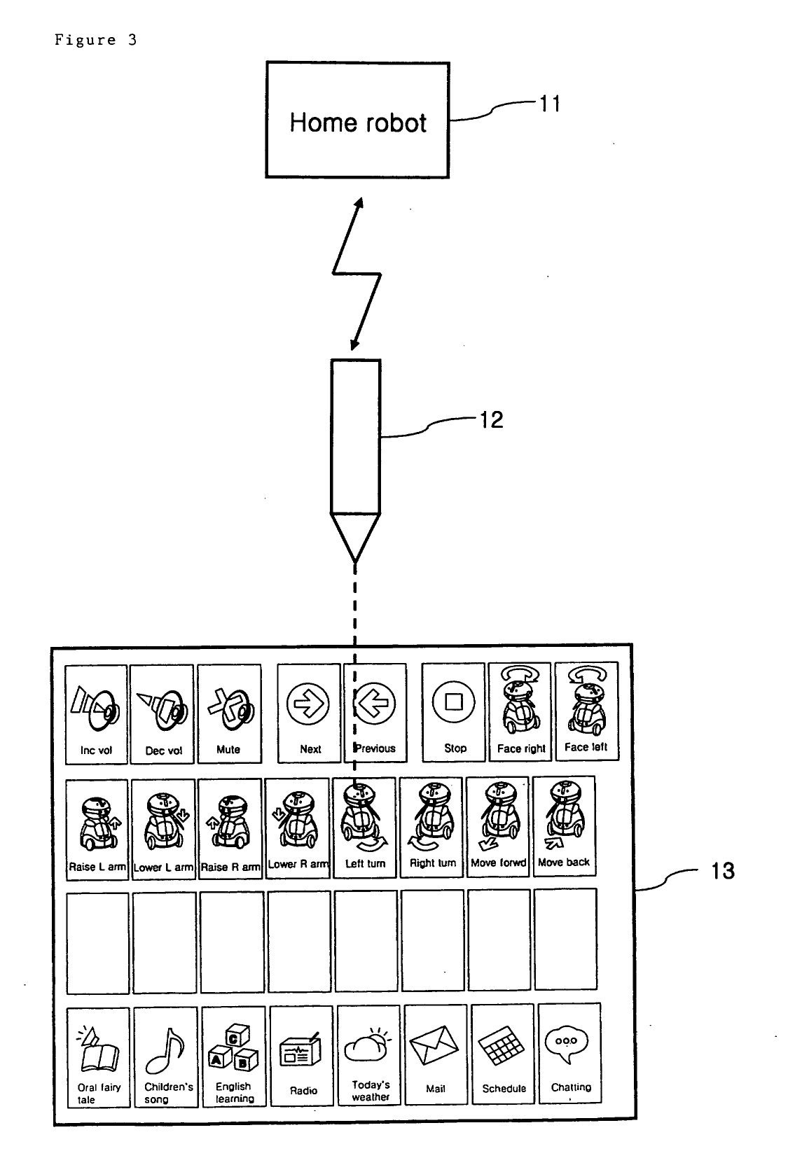

When a specific pictorial symbol of the menu selection card 13 is selected using the optical reader 12, as illustrated in FIG. 3, a minute code appears, as shown in FIG. 1.

Accordingly, when a user selects a specific pictorial symbol using the optical reader 12 while viewing the menu selection card 13 so as to select a menu option corresponding to a desired action command or desired multimedia content, the image of a minute code, printed along with a pictorial symbol, can be recognized by the printed optical reader 12.

Furthermore, in order to allow the meaning of each pictorial symbol to be more easily recognized by a user, descriptive text (for example, “increase volume”) may be indicated below each pictorial symbol, as illustrated in FIG. 2. Of course, a minute code identical to that printed on a pictorial symbol is printed in the descriptive text.

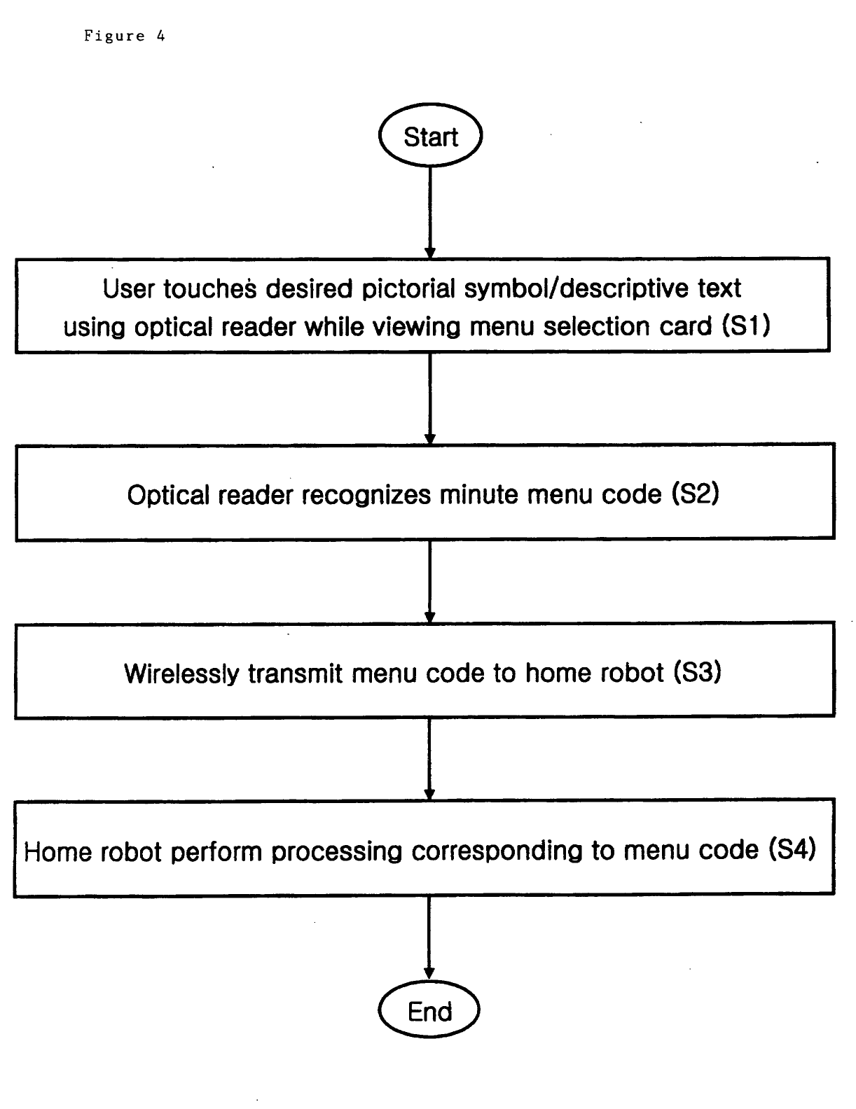

Now, a procedure in which a home robot recognizes the code of a menu option, selected by a user, via the menu card of the present invention is described in detail with reference to FIGS. 3 and 4 below.

First, the user of a home robot 11 touches a desired pictorial symbol using the optical reader 12 while viewing the menu selection card 13 so as to select a desired menu option at step S1. Referring to FIG. 3, the optical reader 12 selects a left-turn menu option, located in the second row of the menu selection card 13. Of course, if there is descriptive text, the descriptive text may be touched using the optical reader 12.

Then the optical reader 12 recognizes a minute code printed along with the pictorial symbol/descriptive text at step S2, and wirelessly sends the menu code to the home robot 11 at step S3.

The home robot 11, which has received the menu code, recognizes a menu option (an action command, multimedia content, or the like), selected by the user, via the menu code. In the case where an action command is selected, related processing, such as the formation of a drive signal for a motor or relay (data about the drive of each motor for a left turn is generated therein or is received from a remote service server (not shown)). In the case where multimedia content has been selected, processing corresponding to the selected content is performed at step S4.

As a result, as described above, when a user is allowed to select a specific pictorial symbol of the menu selection card using the menu selection card 13 on which minute menu codes associated with selectable menu options are printed along with pictorial symbols adapted to represent the menu options, the user can select a desired menu option (an action command or multimedia content) in one step because the selectable menu options are included in a single card, therefore it is not necessary to press buttons several times, unlike the prior art.

Furthermore, since the pictorial symbols associated with the selectable menu options are drawn, as illustrated in FIG. 2, the meanings of the menu options can be easily understood via the pictorial symbols, with the result that the menu selection card of the present invention can be a menu selection card for a home robot that is very convenient for an infant or elementary school child.

Additionally, since codes corresponding to the selectable action commands or multimedia content are transmitted to the home robot 11, the problem of a low recognition rate, which is obtained in the case of issuing voice commands in the prior art, can be overcome.

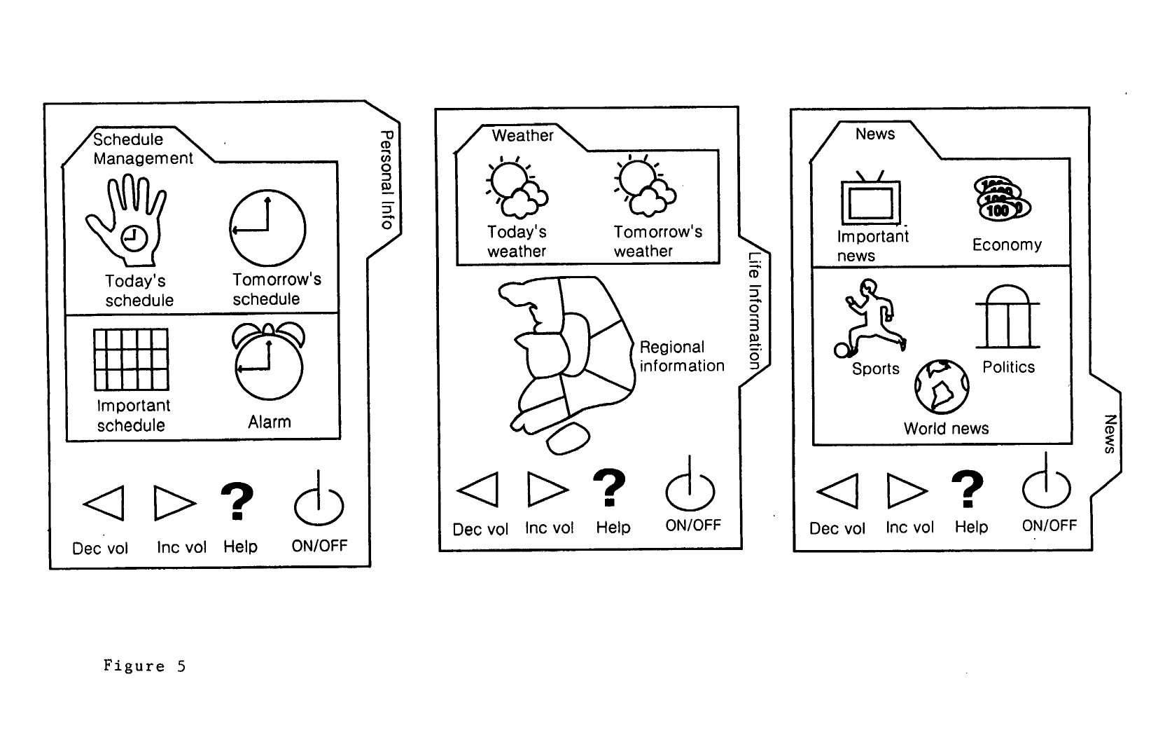

Meanwhile, although all menu options have been described as existing in a single menu selection card, a method in which a menu book having a plurality of menu selection cards (or pages) is provided as illustrated in FIG. 5 and all associated menu options exist in each of the pages (in the example of FIG. 5, the cards of a menu book are menu selection cards for “personal information,” “life information” and “news,” respectively) may be used in the case where it is difficult to arrange all pictorial symbols for the menu options in a single menu selection card because a large number of operational menu options and various pieces of multimedia content exist. Of course, if a table of contents is provided for the convenience of the user of a menu book, the user can easily search for and select a desired menu option. The table of contents enables a user familiar with a PC's Windows scheme to use a menu book based on the same scheme, with the table of contents of the menu book being associated with the desktop of PC Windows, the chapters of the menu book being associated with respective folders of Windows, and the pictorial symbol menu options being associated with respective executable files of the folders of Windows.

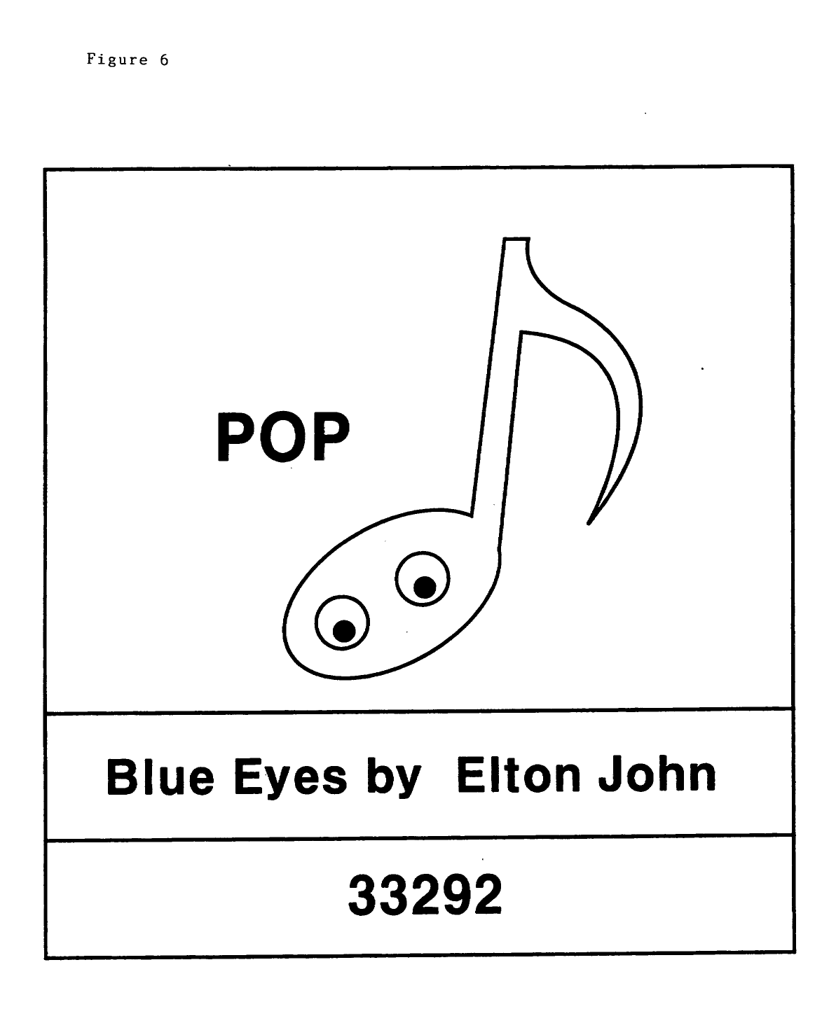

Furthermore, in the case of a music menu book for Karaoke content, it is difficult to represent respective songs using respective pictorial symbols. When, as illustrated in FIG. 6, for each song, the title of the song (in FIG. 6, “Blue Eyes” sung by Elton John) and a song number (in FIG. 6, “33292”) are printed along with a pictorial symbol corresponding to the type of song, such as a new song, a favorite song, a children's song, a popular song, or classical music (in FIG. 6, a pictorial symbol representing a popular song), the user can become aware of the type of song via the pictorial symbol, identify the song via the title of the song, and then select the song number by selecting the type pictorial symbol. The user can use the method by selecting the type of the song, the title of the song or the song number using an optical reader, lo by uttering the song number and thus making a home robot become aware of the song number, or by pressing the numeral buttons of a home robot corresponding to the song number.

Meanwhile, like the third row of FIG. 2, in order to allow a user to construct desired actions (such as a greeting action, a surprised action, a joyful action, or the like), a row in which there are no pictorial symbols and only minute codes (printed in pure black K) exist is provided. The user may draw pictorial symbols for desired actions and descriptive text for the desired actions in a color other than pure black K, and the user may perform programming in the home robot or service server so that the desired actions are constructed using combinations of the basic actions of the first and second rows.

Additionally, if code numbers are printed along with respective pieces of descriptive text to prepare for the case where minute codes printed on a card are not sufficiently recognized due to scratches or deterioration, menu codes can be transmitted to a home robot even in the case of deterioration of the card by prompting a user to directly input a corresponding code value through the manipulation of the numeral buttons of a home robot, or to utter a code, so that the code can be recognized via voice, in the case where it becomes difficult to recognize the code using an optical reader.

Furthermore, in order to prepare for the case where minute codes printed on a card are not sufficiently recognized due to scratches or deterioration, and in order to prevent the recognition rate from decreasing due to the problem of the difference utterances that occurs in the prior art recognition technology (the command “increase volume” is uttered using different wordings, such as “increase sound,” “volume up,” or “high volume”) because the users cannot remember all commends, when a method, in which descriptive text is uttered as it is (“increase volume”) and a home robot recognizes a command by recognizing the utterance, is used in an auxiliary fashion, the same utterance can be made for the same command, therefore the voice recognition rate can be increased.

Meanwhile, although, in FIG. 2, pictorial symbols (printed along with minute codes) for various menu options of a home robot have been illustrated as being arranged in a single card, the menu selection card of the present invention may be formed in the form of a specific card dedicated to a specific application field (content).

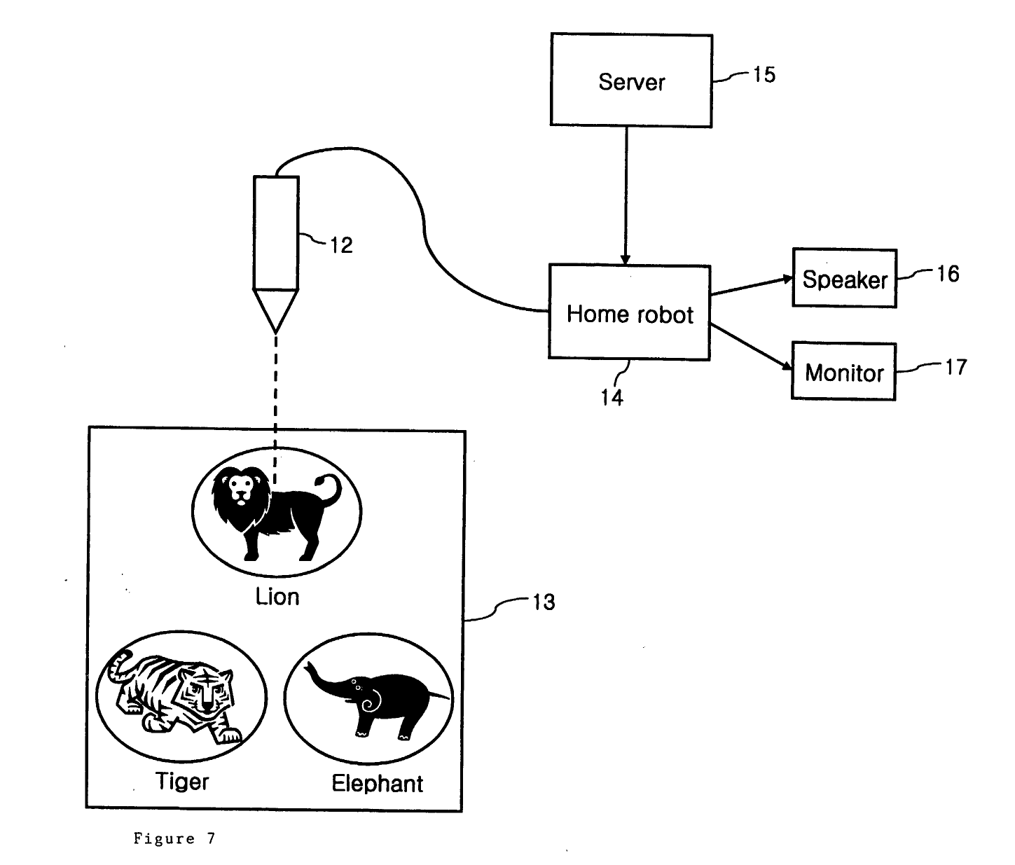

For example, in the case where the multimedia publication “the Animal Kingdom” is played in a home robot, the pictorial symbols and names of animals are printed on each page, as illustrated in FIG. 7, and minute codes (not shown) are printed on the pictorial symbols and the names. Accordingly, when a user (infant or child) selects, for example, the pictorial symbol or name of a lion using the optical reader 12, a code, printed along with the pictorial symbol and the name and adapted to be similar to that of FIG. 1, is read by the optical reader 12 and is transmitted to a home robot 14. Thereafter, when the home robot 14 transmits the code to the server 15, the server 15 transmits voice and video data corresponding to the code to the home robot 14, and the home robot 14 plays the voice and video data, so that voices corresponding to the pictorial symbol of a lion (for example, “the lion is an animal that lives in grasslands . . . ”) through a speaker 16 and the images of the lion are displayed through a monitor 17. Of course, the server 15 transmits related motion data, along with voice and video data, to the home robot 14, so that a motion can be performed at the same time that an utterance is made and images are played.

Accordingly, if a menu selection card suitable for each multimedia publication is manufactured and sold along with the multimedia publication, a user can perform a desired menu option by selecting a corresponding pictorial symbol from the menu selection card using the optical reader 12 and transmitting information about the selected menu option to the home robot 14. In the meantime, the user can play multimedia content by selecting a pictorial symbol on the multimedia publication and transmitting the code information of the selected pictorial symbol to the home robot.

Additionally, the menu selection card of the present invention can be used for interactive content.

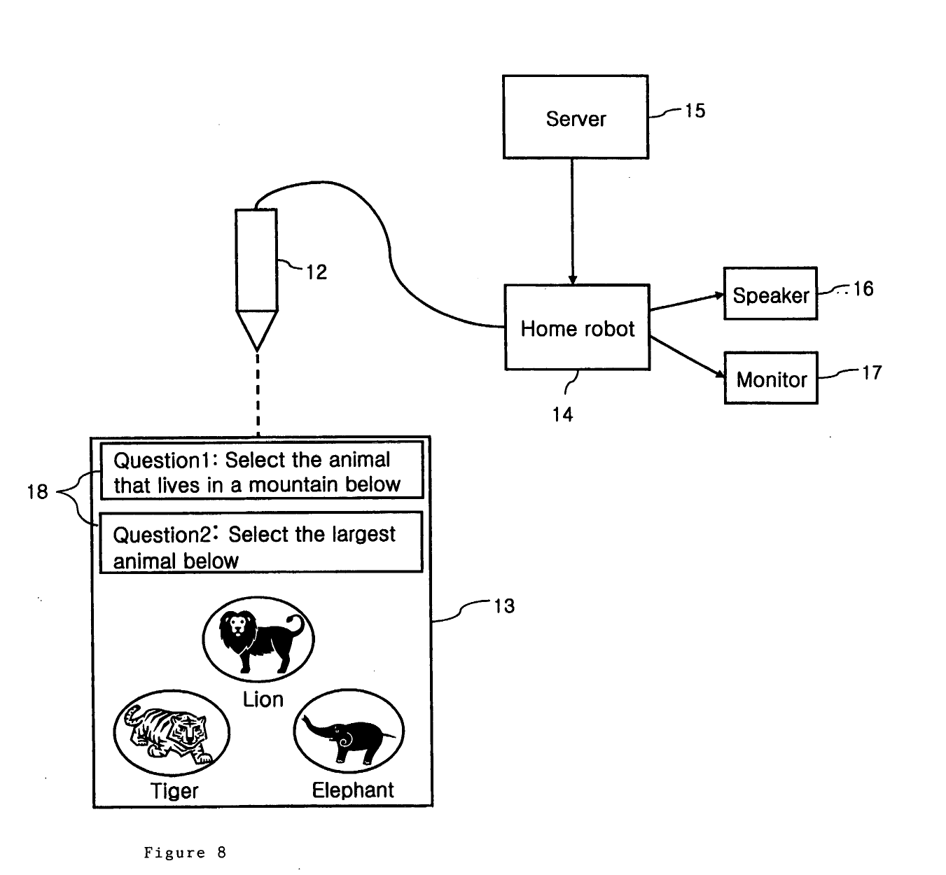

For example, when a user selects the specific question menu option “Please select the animal that lives in a mountain below” from the question menu options 18 of the menu selection card 13 using the optical reader 12, as illustrated in FIG. 8, a question menu code corresponding to the selected question menu option is transmitted to the server 15 through the home robot 14, related voice data is transmitted from the server 15 to the home robot 14, and the related utterance “Please select the animal that lives in a mountain below” is made in the home robot 14. Thereafter, when the user selects the pictorial symbol of an animal that is guessed to be the correct animal, using the optical reader 12, a menu code corresponding to the selected pictorial symbol is transmitted to the server 15 via the home robot 14. Subsequently, if the transmitted menu code is a menu code for the pictorial symbol of a tiger, the server 15 transmits voice data related to the utterance “correct answer” to the home robot 14, and thus the home robot 14 makes the utterance. In contrast, if the transmitted menu code is a menu code for the pictorial symbol of another animal (a lion or an elephant), the server 15 transmits voice data related to the utterance “Wrong answer. Please try again” to the home robot 14, and thus the home robot 14 makes the utterance, so that the user can select another animal.

Therefore, for such interactive content, menu codes may be associated with sentences, rather than pictorial symbols, in which case the interactive content can be excellent learning material for infant or child users.

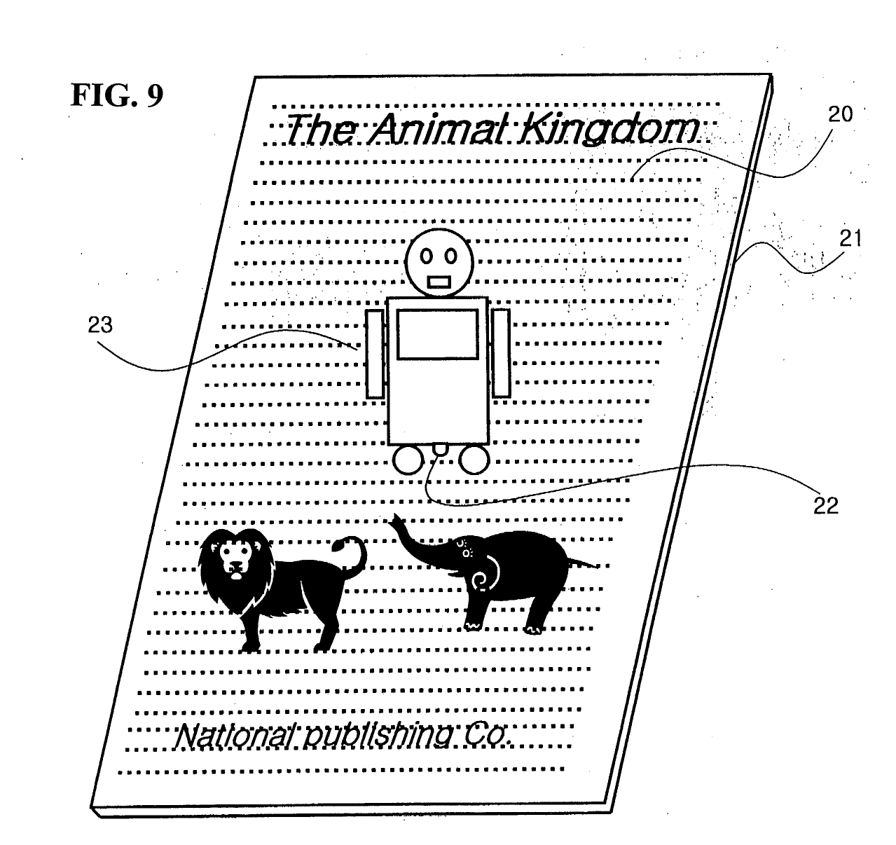

Meanwhile, although, in FIG. 1, minute codes have been illustrated as being used as the menu codes of the menu selection card 21 and a plurality of menu options have been illustrated as existing on a single menu selection card 21, there may be a variant of the embodiment of FIG. 7 in which an optical reader 22 is mounted on the lower portion of a home robot 23 and only a single menu code 20 (in FIG. 9, corresponding to the menu option for the oral narration of “the Animal Kingdom”) is printed on each menu selection card 21, as illustrated in FIG. 9. When a user locates the home robot 23 on the menu selection card 21 corresponding to a desired menu option, the optical reader 22 mounted on the lower portion of the home robot 23 recognizes the menu code and the home robot 23 performs a corresponding operation (for example, the operation corresponding to the oral narration of a fairy tale) on the menu selection card 21. In this case, it is preferred that the home robot 23 perform a correct operation while facing a user straight-on and recognize both a menu option code and an absolute location code (a code for one's own absolute location on the card) to prevent the home robot 23 from moving away from the region of the card.

Furthermore, the menu selection card can designate an operation (a menu option) to be performed and a location at the same time, therefore it is very useful for the autonomous control of a robot.

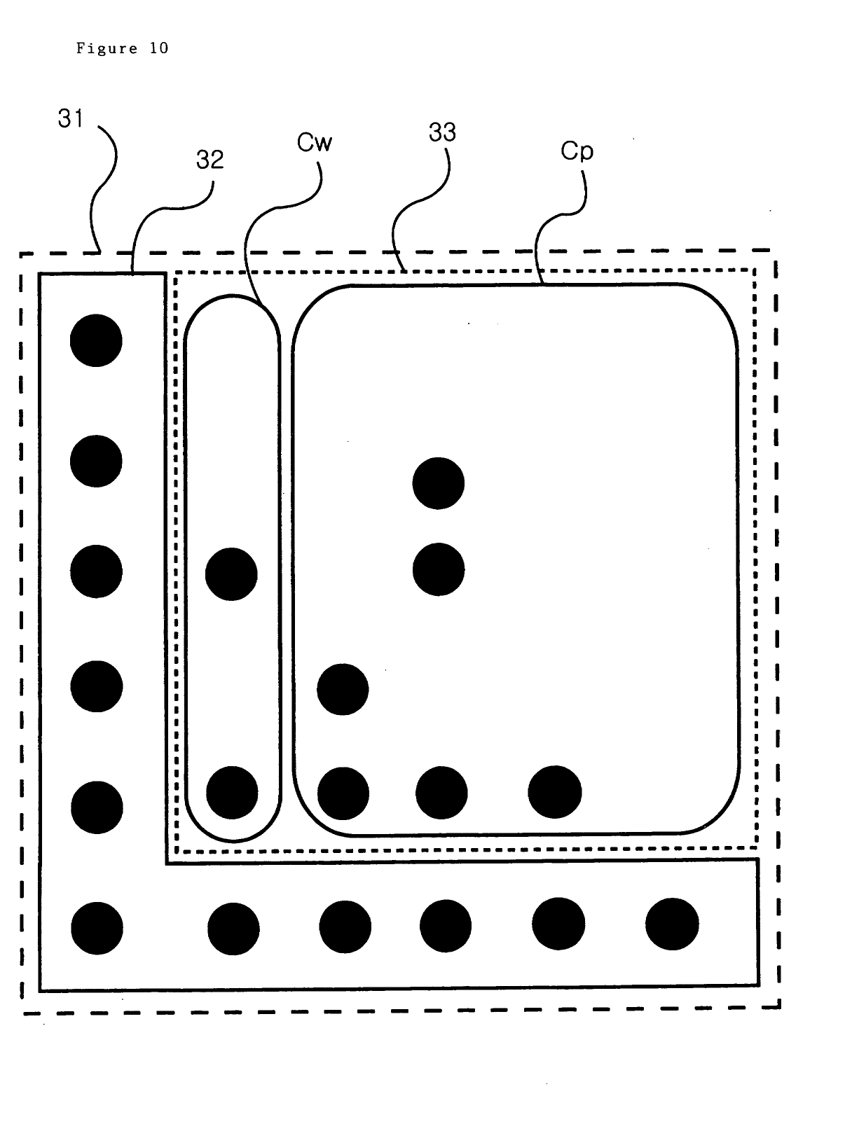

A code that enables both a menu code and a location code (absolute location code) to be recognized is described in brief with reference to FIG. 10.

FIG. 10 illustrates a single code that corresponds to one code of FIG. 1. A single code is composed of a code indicator 31 that is formed in a 6×6 matrix. The code indicator 31 includes a header part 32 that has an L shape, formed by six dots in a lateral direction and six dots in a vertical direction, and forms a reference for this code, and a code information part 33 that exists inside the header part 32 and indicates a code value.

The code information part 33 of FIG. 10 is formed in a 5×5 matrix, and is illustrated as representing (2⁵)*(2⁵)*(2⁵)*(2⁵)*(2⁵)=33,554,432 codes. FIG. 10 is simplified in order to easily describe the 2D code of the present invention. If the number of dots that constitute the matrix increases, a large number of code values can be represented.

In this case, for example, the first column of the code information part 33 may be assigned to a menu code Cw, and the four remaining columns may be assigned to an absolute location code Cp with two columns assigned to an X-directional absolute coordinate and two columns assigned to a Y-directional absolute coordinate. In this case, the menu code Cw can designate one of 2⁵=32 menu options, and the absolute location code Cp can designate one of a total of 1,048,576 absolute locations because it can support (2⁵)*(2⁵)=1,024 values in each of X and Y directions. In particular, X-directional and Y-directional absolute coordinates can be immediately determined by recognizing a binary pattern of dots in the remaining four columns.

Meanwhile, in FIG. 10, the code indicator 31 has been illustrated as being formed in a 6×6 matrix and the code information part 33 has been illustrated as being formed in a 5×5 matrix for convenience of description. However, if a 2D code is printed in a precise fashion, for example, the code indicator 31 is formed in a 10×10 matrix, it is possible to designate a larger number of operation modes and a larger number of absolute locations.

Furthermore, when the optical reader 22 mounted on the lower portion of the home robot 23, having received a captured image of a 2D code video similar to that of FIG. 1, transmits the captured image to the server 15 of FIG. 7, the server 15 rotates the captured image counterclockwise and stops the rotation of the image when a forward header pattern (a pattern having 6 dots in a lateral direction and 6 dots in a vertical direction; in FIG. 1, the L-shaped pattern of the header part 32) appears. The angle of the rotation is an angle that the home robot 23 forms with a forward reference position first on the menu selection card 21 in a clockwise direction. When the forward header part 32 appears, the server 15 detects the values of the menu code Cw and the absolute location Cp from the arrangement of the dots of the code information part 33.

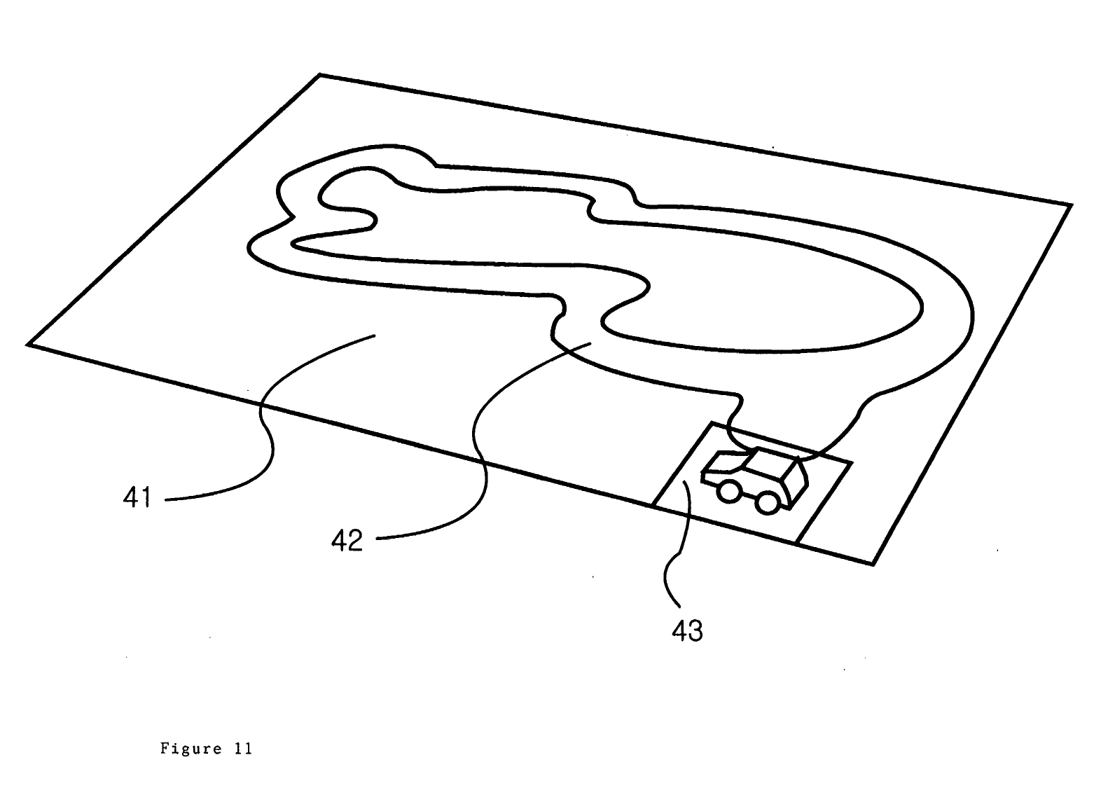

Meanwhile, in the above description, the absolute location codes Cp have been described as being arranged throughout the menu selection card. In another method, in the case of a line tracing race card, as described in FIG. 11, only absolute location codes Cp are printed on a track portion 42 and only menu codes Cw are printed on a portion 41 other than the track portion 42. In this case, when a home robot (in FIG. 11, illustrated in the form of a racing car) is placed on a track race card first, the robot searches for a menu code Cw while moving about, and then searches for an absolute location code Cp while moving about. Thereafter, when the robot enters the track and finds the absolute location code Cp, the robot is caused to move along the track to a starting location 43 and to start a line tracing race.

Meanwhile, although, in the above description, descriptions have been made only in conjunction with the multimedia publication card and the line tracing race card, the present invention can be applied to various board game cards and to a robot soccer ground card using the home robot of the present invention. Furthermore, the card of the present invention may be used as bedding, a living room carpet, a kitchen floor pad, a study room card, or the like. In this case, when a robot is placed on the card, an initial operation related to the card, for example, in the case of the study room card, an initial operation of providing notification of that day's schedule of a school or private academy and homework via a screen or voice may be performed.

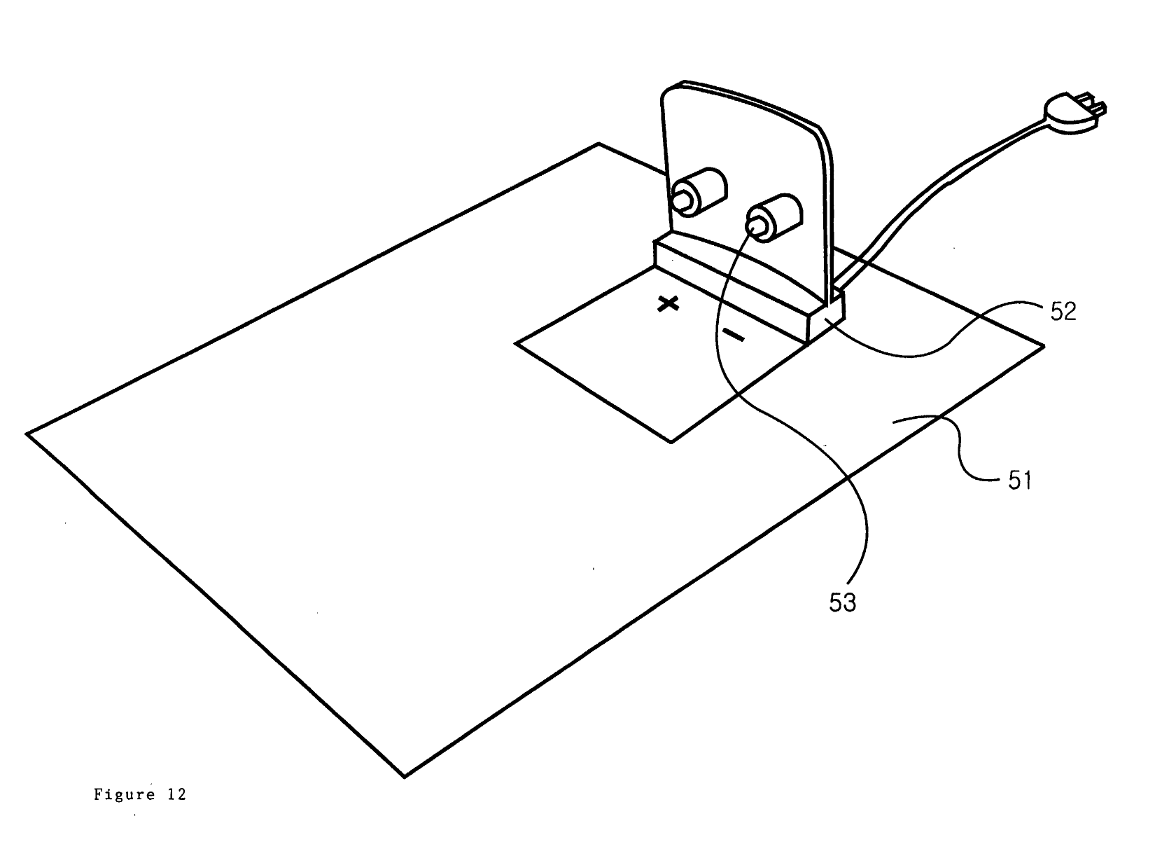

Furthermore, the menu selection card can be combined with another device from the point of view of a location and can help a robot perform a specific operation. For example, as illustrated in FIG. 12, a charging device 52 is placed on a charging menu card (menu pad) 51 and the contacts 53 of the charging device 52 are arranged at predetermined locations. When a user places a robot on the charging menu card 51, the robot recognizes a charging operation code and can immediately detect the relative direction and location of the contacts 53 of the charging device 52. Accordingly, if the robot needs to be charged, the robot can move toward the contacts 53 of the charging device 52 using information about the direction and the location and then perform a charging operation.

According to the present invention, in a home robot system, a user can select various menu options (action commands, multimedia content and so on) while easily recognizing them, and a home robot or a remote server can easily recognize the selected menu options also.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A robot system, comprising:
a menu selection card on which minute codes corresponding to respective menu options selectable in a robot system are printed along with pictorial symbols corresponding to the respective menu options;
an optical reader which recognizes the minute codes corresponding to the respective pictorial symbols; and
a robot main body which receives a minute code corresponding to a specific pictorial symbol, selected by the optical reader from the menu selection card, from the optical reader, and performs an operation corresponding to the received code.

2. The robot system as set forth in claim 1, wherein the optical reader is separate from the robot main body, and the selection of the specific pictorial symbol is performed in such a way that a user selects the specific pictorial symbol from the menu selection card using the optical reader.

3. The robot system as set forth in claim 1, wherein the optical reader is integrated with the robot main body, and, when the robot is located on the menu selection card, the specific pictorial symbol is read by the optical reader and then an operation corresponding to the read specific pictorial symbol is performed.

4. The robot system as set forth in claim 1, further comprising a plurality of pieces of descriptive text that are placed near the respective pictorial symbols and respectively correspond to the minute codes.

5. The robot system as set forth in claim 1, further comprising code numbers that are placed near the respective pictorial symbols and respectively correspond to the minute codes.

6. The robot system as set forth in claim 1, wherein the pictorial symbols are pictorial symbols provided by a user, and the user performs programming so that processing corresponding to each of the pictorial symbols can be carried out by the robot main body.

7. The robot system as set forth in claim 1, wherein the menu selection card is a dedicated card for a specific multimedia content.

8. The robot system as set forth in claim 7, wherein the dedicated card for a specific multimedia content is a dedicated card for interactive content.

9. The robot system as set forth in claim 1, wherein the menu selection card comprises a plurality of cards that constitute a menu book.

10. The robot system as set forth in claim 1, wherein the menu options designate respective actions of the robot system.

11. The robot system as set forth in claim 3, wherein each of the minute codes is a single code in which a menu code indicating information about a menu option is combined with an absolute location code indicating an absolute location of the robot system on the card.

12. The robot system as set forth in claim 11, wherein the single code comprises a code information part designating a code value and a header part corresponding to a reference pattern for reading of the code value, and the code information part comprises the menu code and the absolute location code.

13. The robot system as set forth in claim 11, wherein the card is combined with another device in a point of view of a location, and, when the robot is located on the card, the robot recognizes an operation from the menu code of the card and recognizes a location and direction of the device from the absolute location code of the card.

14. The robot system as set forth in claim 13, wherein the device is a charging device and the operation code is a charging operation code.

15. The robot system as set forth in claim 1, wherein the operation of the robot main body is performed in such a way that the code is transmitted to a remote server, and the robot main body receives and performs voice, video or motion data corresponding to the code.
